(19) United States
(12) Patent Application Publication
(10) Pub. No.: US 2009/0192843 A1
(43) Pub. Date: Jul. 30, 2009

(54) METHOD AND SYSTEM FOR TIME-STANDARD DEVELOPMENT

(76) Inventors: John F. AYALA, San Antonio, TX (US); Harry S. Whiting, Athens, OH (US); Thomas Sandoval, Corpus Christi, TX (US)

Correspondence Address: WINSTEAD PC, P.O. BOX 50784, DALLAS, TX, 75201, US

(21) Appl. No.: 12/021,859

(22) Filed: Jan. 29, 2008

(51) Int. Cl. G06Q 10/00

(52) U.S. Cl. 705/7

(57) ABSTRACT

A performance-standard-computation method. The method includes selecting a task including a series of component steps, filming a worker performing each of the component steps of the task, reviewing the output of the filming step, using a data-acquisition device to record a plurality of process data wherein the step of using the data-acquisition device overlaps, at least in part, with the reviewing step, transferring the process data to a data-assessment tool, and using the data-assessment tool to calculate a plurality of performance standards relating to the task.

### BACKGROUND

1. Field of the Invention

The present invention relates to the development of time standards. More particularly, but not by way of limitation, the present invention relates to tools for use in the development of time standards in a re-manufacturing environment.

2. History of Related Art

Tools for the estimation of production costs are of particular importance in the manufacturing industry. One tool that is widely used is the establishment of performance standards. A variety of methods exist for the computation of performance standards. One such method is commonly referred to as a time-and-motion study. A time-and-motion study typically involves measuring average time for each production step and incorporating a variety of factors including worker fatigue, job complexity, job standardization, and repeatability to determine performance standards for each production step. Two such measurements commonly used as performance standards are cycle time and take time. Cycle time is defined as the total time required to move a product through a production process, while take time or “beat time” is defined as the rate at which a completed product must be finished in order to satisfy customer demand. Accurate computation of performance standards enables management to set standards for the number of workers needed, the required hours of work per job, the production output, scheduling, forecasting, and a variety of other production and cost-related metrics.

### SUMMARY OF THE INVENTION

A performance-standard-computation method. The method includes selecting a task including a series of component steps, filming a worker performing each of the component steps of the task, reviewing the output of the filming step, using a data-acquisition device to record a plurality of process data wherein the step of using the data-acquisition device overlaps, at least in part, with the reviewing step, transferring the process data to a data-assessment tool, and using the data-assessment tool to calculate a plurality of performance standards relating to the task.

A performance-standard-computation system for an operation, the operation including a plurality of component steps. The system includes a filming device placed in view of a worker and a work area of the operation, a data-acquisition device adapted to receive a plurality of process data related to the operation, the plurality of process data being input based, at least in part, on observation of an output of the filming device, and a data-assessment tool electronically coupled to the data-acquisition device, the data-assessment tool adapted to apply a plurality of factors to the plurality of process data to compute at least one performance standard relative to the operation.

### BRIEF DESCRIPTION OF THE DRAWINGS

The accompanying drawings, which are incorporated in and constitute a part of this specification, illustrate several embodiments of the invention and together with the description, serve to explain principles of the invention.

FIG. 1 is a process flow diagram illustrating a method for computing performance standards;

FIG. 2 is a system diagram illustrating various components used for computing performance standards;

FIG. 3 is a partial illustration of an input page of a data-manipulation spreadsheet for use in computing performance standards;

FIG. 4 is another partial illustration of the input page of the data-manipulation spreadsheet of FIG. 3;

FIG. 5 is an illustration of a combination sheet of the spreadsheet of FIG. 3;

FIG. 6 is an illustration of a summary page of the spreadsheet of FIG. 3;

FIG. 7 is an illustration of a chart data page of the spreadsheet of FIG. 3; and

FIG. 8 is an illustration of a personal fatigue and delay-factor-computation sheet of the spreadsheet of FIG. 3.

### DETAILED DESCRIPTION OF ILLUSTRATIVE EMBODIMENTS OF THE INVENTION

Reference is now made in detail to exemplary embodiments of the present invention illustrated in the accompanying drawings. Wherever possible, the same reference numerals are used throughout the drawings to refer to the same or similar parts.

There are many techniques for performing a time-and-motion study. Most methods of computing performance standards involve manually timing production steps, manually recording times, and calculating the standard time using either manual calculations or a commercially available spreadsheet. These methods are often very labor-intensive. When these methods are used, significant time is often spent timing each activity to the second and taking notes. In addition, the level of inaccuracy rises as the chances of overlooking unexpected and unobserved details grow. As a result, multiple observations of each step must be made as the methods are dependent upon the observer not missing critical process steps. It is estimated that this method of performance-standard computation requires about ten hours of analysis to compute one time standard.

Additionally, the use of performance standards is subject to a variety of functional limitations. In particular, manufacturing processes having a high degree of variability do not lend themselves to accurate performance-standard development. This variability is typically found in custom manufacturing or re-manufacturing operations where the time required for a particular process might vary dramatically from one production run to the next. As a result, attempts to develop performance standards for these types operations rarely take all the necessary variables into account and are typically fraught with accuracy problems. In addition, the performance of a time-and-motion study can be disruptive to normal production, which can also lead to inaccurate results. When timing production activities by hand, production workers tend to become increasingly aware of the fact that they are being observed, and may start to exceed the normal pace of work. This obviously leads to inaccurate data and inaccurate performance standard computation. In addition, the increased pace of work can also compromise production quality and increase the number of products requiring re-working. These potential problems dramatically increase the cost of computing performance standards.

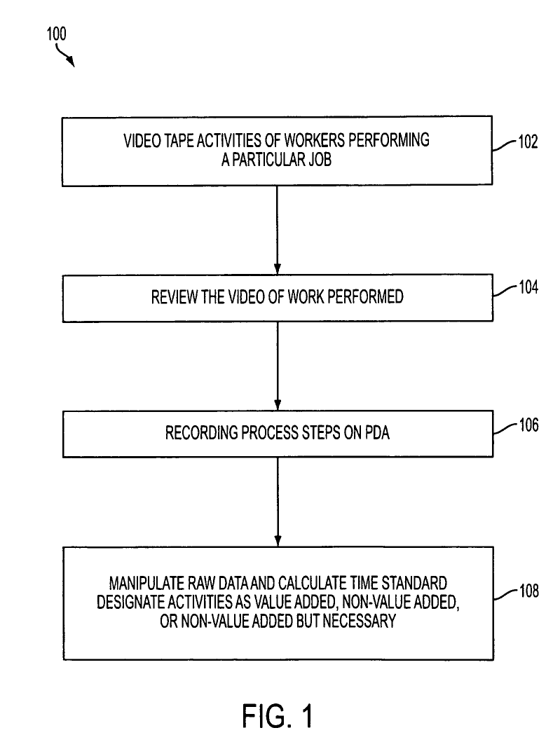

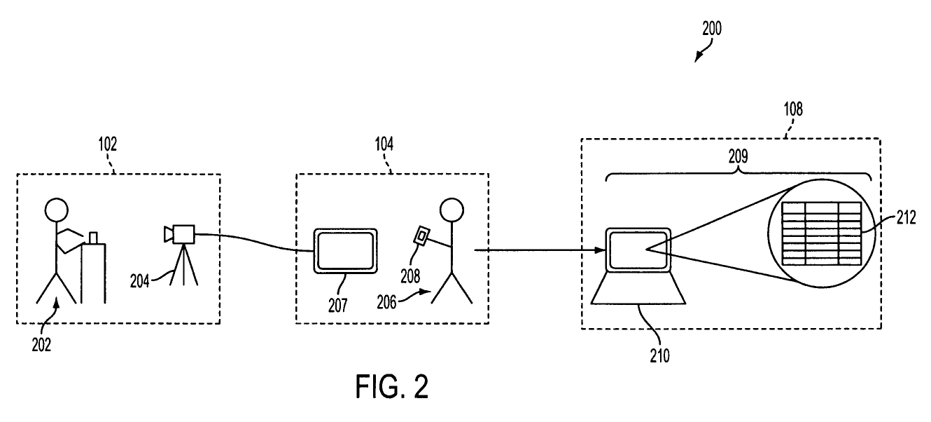

Referring first to FIGS. 1 and 2, there is illustrated a method 100 and a system 200 of computing a performance standard. In step 102, a filming device 204 is positioned to observe the activities of a worker 202. The filming device 204 may be any appropriate video recording device, but is typically equipped with zoom capability and capable of recording, for example, to either video home system (VHS) cassette or a digital video disc (DVD). The filming device 204 is typically positioned in such a way so as not to interfere with the activities of the worker 202 or be otherwise distracting to the worker 202. If the filming device 204 is discreetly placed, the worker 202 will not have the sensation that he or she is being continuously observed and will perform his or her job related tasks as he or she normally would. The filming device 204 can provide a time stamp on each frame of an output 207, which can be later used to reconcile any discrepancies. In addition, the output 207 provided by the filming device 204 provides a permanent record of the time observation and can be used to document any improvements to the process.

Referring still to FIGS. I and 2, in step 104, an observer 206 reviews the output 207 produced by the filming device 204. In this step, the observer 206 is typically reviewing a VHS, DVD, or other similar recording that allows the observer 206 the ability to review a section of the output 207 a second or third time, and, if necessary, slow down the playback speed. However, those having skill in the art will appreciate that the output 207, reviewed by the observer 206, need not be a recording, but could also be a live feed with no intermediate recording generated.

In step 106, the observer 206 records his findings on an electronic data-acquisition device 208. The electronic data-acquisition device 208 may be any appropriate device, but is typically a personal data assistant (PDA) equipped with an internal clock and capable of transmitting the acquired data to an assessment tool 209. Additionally, the electronic data-acquisition device 208 is typically equipped with a commercially available data-acquisition software package such as the Workstudy+™ 3.0 software package available from Quetech Ltd. of Waterloo, Ontario, Canada. In typical operation, the observer 206 enters each process step into the electronic data-acquisition device 208 during the observation phase of the time study. The internal clock of the electronic data-acquisition device 208 records all of the start and stop times for each process step. Time normally spent by observer 206 taking notes, timing each activity, and ensuring that no activities are overlooked is replaced by technology in a typical embodiment.

Referring still to FIGS. 1 and 2, in step 108, the data recorded in the electronic data-acquisition device 208 is transmitted to the assessment tool 209 for analysis and manipulation. While a typical embodiment has the data transferred in its raw form with no manipulation, those having skill in the art will appreciate that an additional software package may also be needed to convert the data into a format acceptable to the assessment tool 209. This data transmission may be by any practical means such as, but not limited to, direct data link, wireless link, or web-based transmission. This direct transmission of data eliminates the need for the observer 206 to re-enter enter data into the assessment tool 209, and thereby eliminates considerable time from the computation process and reduces the opportunity for data-entry error. The assessment tool 209 may be any appropriate device, apparatus, or method, but typically includes a computer 210 equipped with a data-manipulation spreadsheet 212. The spreadsheet 212 may be any commercially available spreadsheet software such as Microsoft Excel® available from Microsoft Corporation. In a typical embodiment, the assessment tool 209 is capable of providing a detailed breakdown of operational tasks used to identify improvement opportunities and establish performance standards.

During typical operation, the assessment tool 209 classifies each process step as “value-added”, “non-value-added”, or “non-value-added but necessary”. The assessment tool 209 then builds a Gantt chart showing, by color code, each process step and the accumulated time to perform the tasks. Those having skill in the art will appreciate that a Gantt chart is a type of bar chart that illustrates a project schedule. In addition, the assessment tool 209 may include the ability to produce other process-summary charts, such as pie or bar charts, as a guide for process improvements. A summary page is automatically generated that provides the performance standard for the task being observed. Those having skill in the art will appreciate that this feature allows an embodiment of the present invention to have the added functionality of use as tool for continuous improvement.

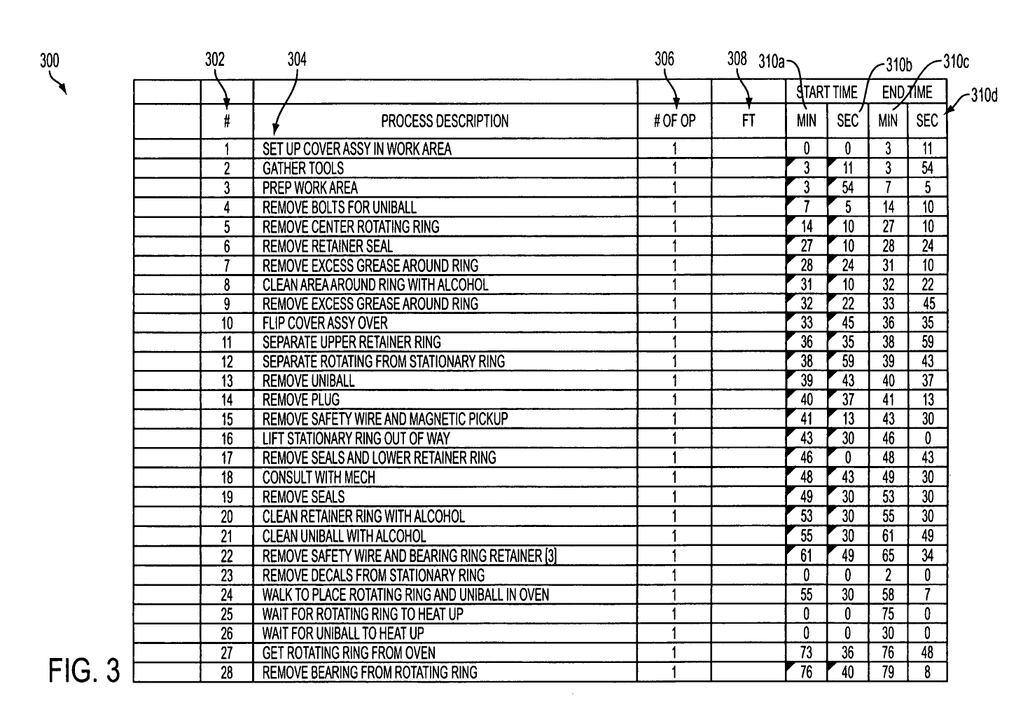

Referring now to FIG. 3, there is shown, by way of example, an illustration of a portion of an input sheet 300 of the spreadsheet 212. In a typical embodiment, the input sheet 300 is populated automatically when data is transferred from the electronic data-acquisition device 208. However, the input sheet 300 may also be manually populated if such data transfer cannot be established. A column 302 is populated with the sequence number of the steps that happened within the process, starting with the number “1”. A column 304 is populated with a description of tasks performed as part of the process. A column 306 is designated for the number of workers performing each task. This number is factored into the final computation of the manual cycle time. The number in the column 306 may automatically default to “1”. However, the number is typically easily changed in the event that more than one operator works on a particular task.

Referring still to FIG. 3, when an operator must walk or travel from one place to another as part of the task, the distance traveled must be taken into account. A column 308 is designated for this purpose. A distanced traveled by the worker 202 may be computed or measured by any appropriate means, but is typically estimated using the assumption that 1 step is roughly equal to about 2 to 2.5 feet. As necessary, adjustments can be made to this assumption to account for the specific stride of the worker 202. To achieve the most accurate results, distance traveled by the worker 202 should be taken into account regardless of the actual length of the trip.

Start and end times, typically in minutes and seconds, for the various production processes are entered in columns 310a-310d. In a typical embodiment, the columns 310c-d, which correspond to a task end time, are linked to the columns 310a-b of the following rows, resulting in the ending time for a particular task equaling the start time of the next task. Start times are maybe linked to the preceding end times in this manner. However, if a start time needs to be adjusted, to accommodate for variations in the process, a start time may be manually entered.

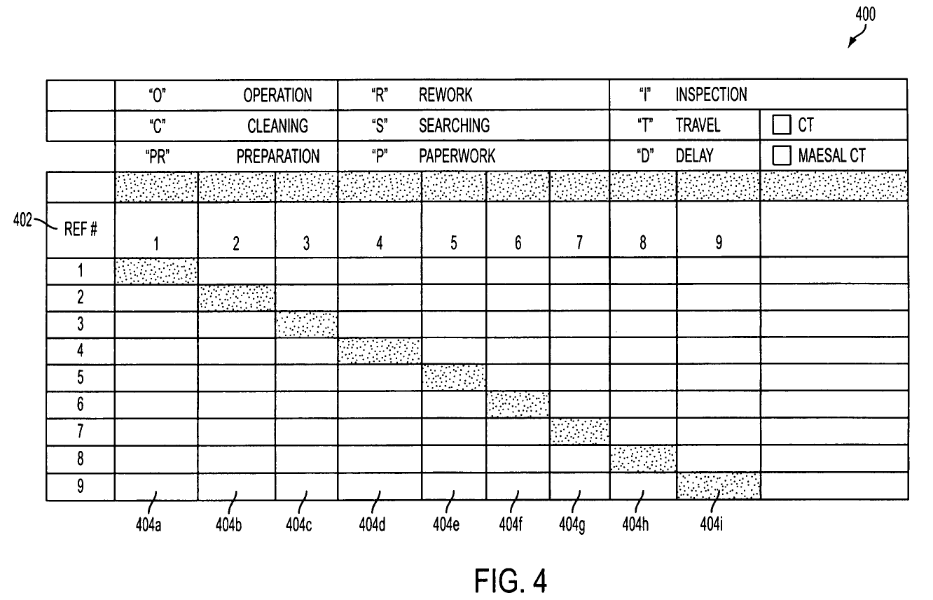

Referring now to FIG. 4, there is shown, by way of example, an illustration of another portion of input sheet 400 of the spreadsheet 212. As before, information contained in the input sheet 400 of spreadsheet 212 is typically automatically populated when data is transferred from the electronic data-acquisition device 208. However, the input sheet 400 may also be manually populated if such data transfer cannot be established. During typical operation, a column 402 contains information related to the categorization of the work activities performed. Specifically, the column 402 contains a number 1 through 9 corresponding to a predetermined list of work categories. These categories are defined in columns 404a through 404i. By way of example, in FIG. 4, an entry of “1” in the column 402 designates the work performed as any value-added operation or activity. An entry of “2” in the column 402 designates the work performed as non-value-added, and related to the cleaning of either the product or the workstation. An entry of “3” in the column 402 designates the work performed as any sort of non-value-added preparation before working on a task, such as gathering or changing tooling. An entry of “4” in the column 402 designates the work performed as non-value-added rework attributable to quality inspection failure, operator error, or other circumstances such as an order change initiated by the customer. An entry of “5” in the column 402 designates work preformed as non-value-added activity related to time spent searching for parts, tools, hardware, or any other item necessary to complete the task. An entry of “6” in the column 402 designates work performed as non-value-added time spent by the worker filling out paperwork as part of the production process. An entry of “7” in the column 402 designates work performed as non-value-added time spent by the worker visually inspecting their work. An entry of “8” in the column 402 designates work performed as non-value-added time spent traveling to acquire tools, chemicals, or other materials necessary to perform the work. An entry of “9” in the column 402 designates any sort of non-value-added delay in the production process.

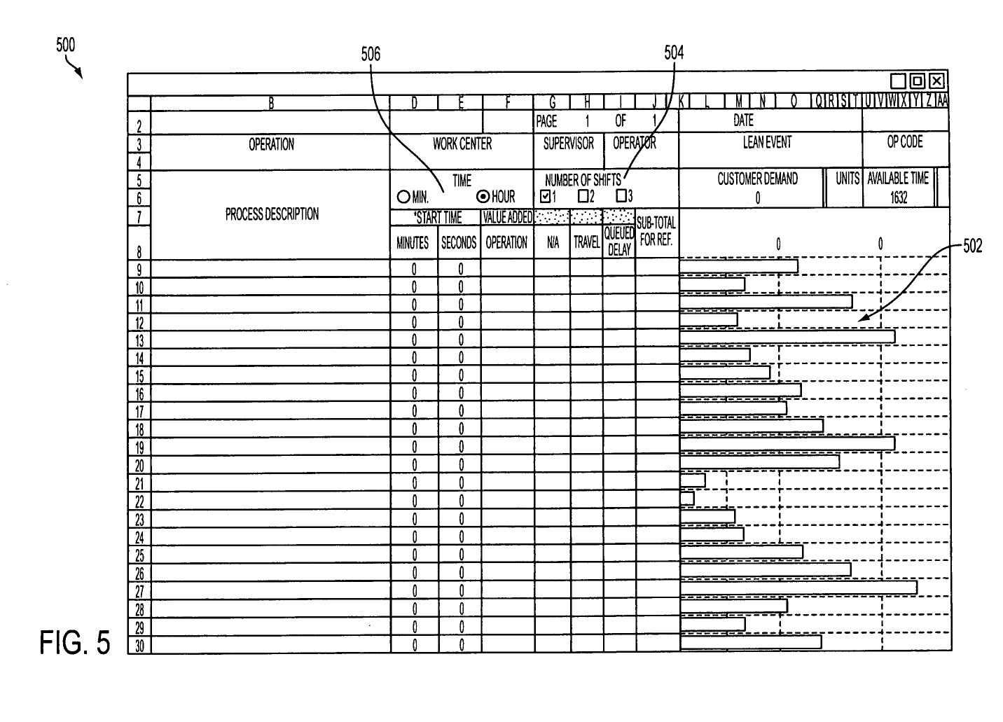

Referring now to FIG. 5, there is shown, by way of example, an illustration of a combination sheet 500 of spreadsheet 212. The combination sheet 500 imports information from the input sheets 300 and 400, and constructs a Gantt chart 502 to provide a visual illustration of the amount of time spent on value-added and non-value-added activities. In a typical embodiment, no data needs to be entered on the combination sheet 500, as all information will be imported from data contained in the input sheets 300 and 400. An option button 504 is provided to allow a user to select the number of shifts working on a particular process. An option button 506 is also provided to allow a user to select whether the process takt time will be calculated in minutes or hours.

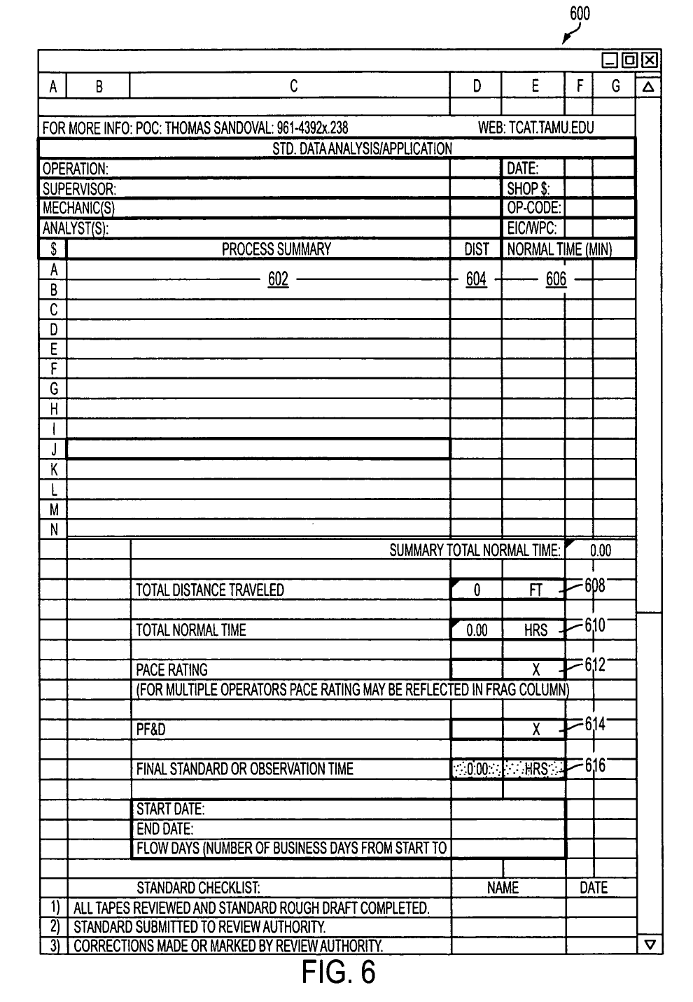

Referring now to FIG. 6, there is shown, by way of example, an illustration of a summary page 600 of spreadsheet 212. Similar to the combination sheet 500, in a typical embodiment, the summary page 600 imports data from the input sheets 300 and 400. Therefore, in a typical embodiment, no data needs to be entered on the summary page 600, as all the information will be imported from the data contained in the input sheets 300 and 400. The summary page 600 includes a process summary section 602 which includes descriptions of each process step performed by a particular worker. A column 604 contains subtotals for the distance traveled by the worker, and a column 606 contains subtotals for the normal time associated with each process step. Below the summary section 602, there is a total distance section 608 that computes the total distance traveled by the worker over the entire process. There is also a total normal time section 610 that computes the total normal time for the entire process. A section 612 provides an input for mechanic pace rating, and a section 614 allow for entry of shop personal fatigue and delay (PF&D) percent. Finally, the total normal time of section 610 is multiplied by the pace rating of section 612 and PF&D factor of section 614 to compute the final standard performance time 616.

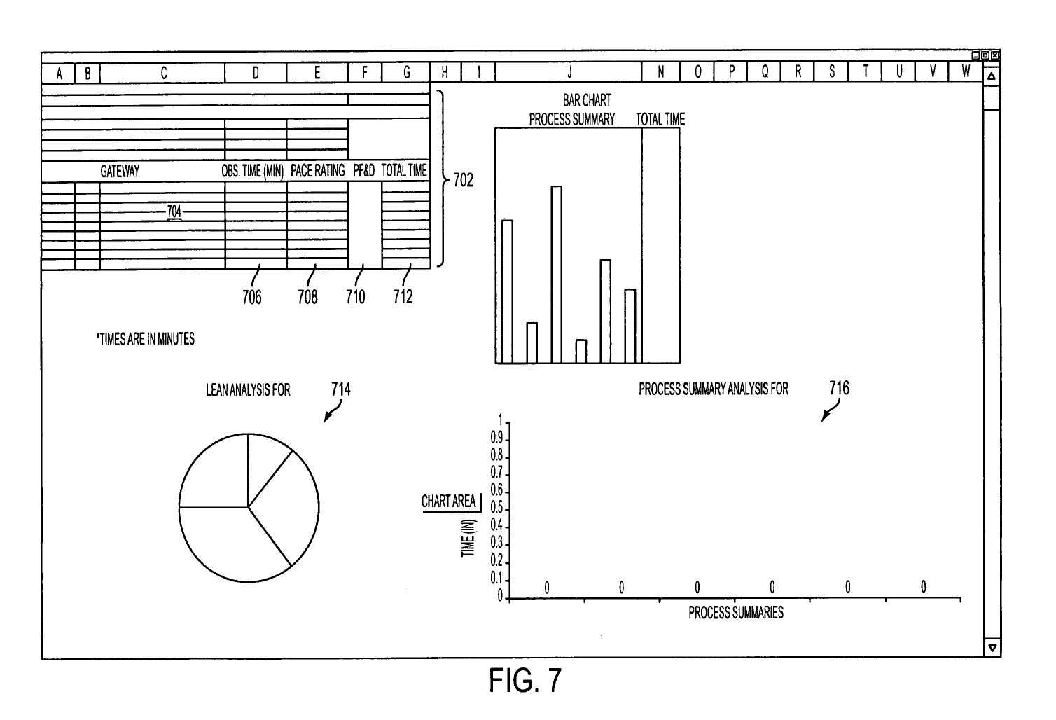

Referring now to FIG. 7, there is shown, by way of example, an illustration of a chart data page 700 of spreadsheet 212. Again, similar to the combination sheet 500, in a typical embodiment, the chart data page 700 imports data from the input sheets 300 and 400. Therefore, in a typical embodiment, no data needs to be entered on the chart data page 700, as all the information will be imported from the data contained in the input sheets 300 and 400. The chart data page 700 includes a summary section 702 that details time spent on each value added or non value added activity. The summary section 702 includes a list of work categories 704, and a total observed time 706. The total observed time 706 is multiplied by a mechanic pace factor 708 and a PF&D factor 710 to calculate a total time 712 for each work category. The total times 712 are then illustrated in two summary charts. The first is a pie chart 714, which provides a visual illustration of how much time was spent on each value added and non value added activity in percent form. The second is a bar chart 716, which provides a visual illustration of how much time was spent on each process sub-step.

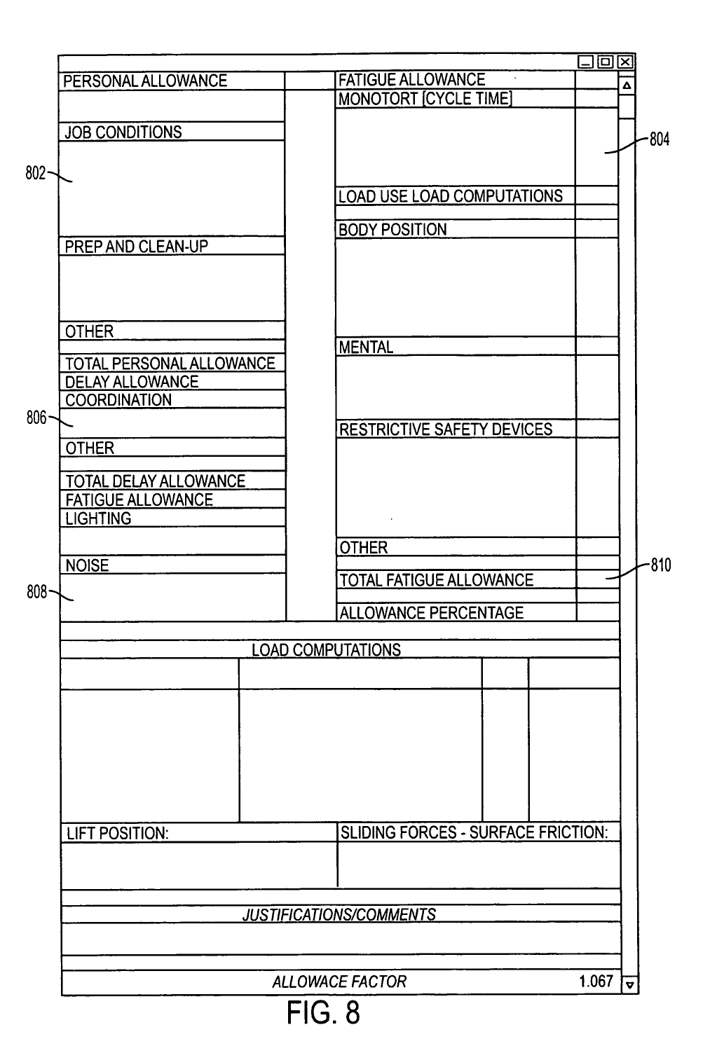

Referring now to FIG. 8, there is shown, by way of example, an illustration of a personal fatigue and delay factor (PF&D) computation sheet 800 of spreadsheet 212. The PF&D computation sheet 800 calculates the PF&D allowances for the process. Personal fatigue and delay allowances are the time allowed the workers to compensate for attending to personal needs, for fatigue, and for delay occurrences due to conditions beyond their control. This percentage is then applied to the total normal time, computed in summary page 600, so that these factors can be considered in the time that is used for setting schedules or production rates. Each section 802-808 of sheet 800 requires user entry of a percent value, and the final PF&D factor 810 is calculated.

Embodiments of the present invention may be implemented in, for example, hardware, software (e.g., carried out by a processor that executes computer-readable instructions), or a combination thereof. The computer-readable instructions may be program code loaded in a memory such as, for example, Random Access Memory (RAM), or from a storage medium such as, for example, Read Only Memory (ROM). For example, a processor may be operative to execute software adapted to perform a series of steps in accordance with principles of the present invention. The software may be adapted to reside upon a computer-readable medium such as, for example, a magnetic disc within a disc drive unit. The computer-readable medium may also include a flash memory card, EEROM based memory, bubble memory storage, ROM storage, etc. The software adapted to perform according to principles of the present invention may also reside, in whole or in part, in static or dynamic main memories or in firmware within a processor (e.g., within microcontroller, microprocessor, or a microcomputer internal memory).

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention as set forth in the foregoing specification and following claims.

1. A performance-standard-computation method comprising:
selecting a task comprising a plurality of component steps;
filming at least one worker performing the plurality of component steps;
reviewing an output of the filming step;
using a data-acquisition device to record a plurality of process data;
wherein the step of using the data-acquisition device overlaps in time, at least in part, with the reviewing step;
transferring the recorded process data to a data-assessment tool; and
using the data-assessment tool to calculate a plurality of performance standards relating to the task.

2. The method of claim 1, wherein the task comprises at least one manufacturing process.

3. The method of claim 2, wherein the at least one manufacturing process comprises a custom re-manufacturing process.

4. The method of claim 1, wherein the data-acquisition device comprises a personal data assistant (PDA).

5. The method of claim 4, wherein the personal data assistant comprises a data-acquisition software package.

6. The method of claim 4, wherein the filming step comprises recording video to a tangible medium for later review.

7. The method of claim 1, wherein the step of transferring the process data comprises transferring data via a direct data link.

8. The method of claim 1, wherein the data-assessment tool further comprises a computer equipped with a spreadsheet software package.

9. The method of claim 1, wherein the plurality of performance standards comprise a time standard for each of the plurality of component steps.

10. The method of claim 1, wherein the plurality of performance standards comprise an analysis of value-added and non-value-added activities.

11. The method of claim 10, wherein the analysis of value-added and non-value-added activities comprises a plurality of graphical representations of value-added and non-value-added time.

12. The method of claim 10, wherein the analysis of value-added and non-value-added activities is used as a continuous-improvement tool.

13. The method of claim 1, wherein the data-assessment tool comprises a personal-fatigue and delay worksheet.

14. The method of claim 1, wherein the plurality of process data comprises a time spent on each component step.

15. The method of claim 1, wherein the plurality of process data comprise a distance traveled by a worker.

16. A performance-standard-computation system for an operation, the operation comprising a plurality of component steps, the system comprising:
a filming device placed in view of a worker and a work area of the operation;
a data-acquisition device adapted to receive a plurality of process data related to the operation, the plurality of process data being input based, at least in part, on observation of an output of the filming device; and
a data-assessment tool electronically coupled to the data-acquisition device, the data-assessment tool adapted to apply a plurality of factors to the plurality of process data to compute at least one performance standard relative to the operation.

17. The system of claim 16, wherein the operation comprises a manufacturing operation.

18. The system of claim 16, wherein the data-acquisition device comprises a personal data assistant.

19. The system of claim 18, wherein the personal data assistant comprises a data-acquisition software package.

20. The method of claim 18, wherein the filming device comprises an apparatus for recording video to a tangible medium for later review.

21. The system of claim 16, wherein the plurality of process data comprise a time spent on each of the plurality of component steps.

22. The system of claim 16, wherein the plurality of process data comprise a distance traveled by a worker.

23. The system of claim 16, wherein the step of transferring the process data comprises transferring data via a direct data link.

24. The system of claim 16, wherein the data assessment tool comprises a computer equipped with a spreadsheet software package.

25. The system of claim 16, wherein the plurality of performance standards comprise a time standard for each of the plurality of component steps.

26. The system of claim 16, wherein the plurality of performance standards comprise an analysis of value-added and non-value-added activities.

27. The system of claim 26, wherein the analysis of value-added and non-value-added activities comprises a plurality of graphical representations of value-added and non-value-added time.

28. The system of claim 26, wherein the analysis of value-added and non-value added activities adapts the system for use as a continuous improvement tool.

29. The system of claim 16, wherein the data assessment tool further comprises a personal fatigue and delay worksheet.
